(19) United States
(12) Patent Application Publication
(10) Pub. No.: US 2017/0182466 A1
(43) Pub. Date: Jun. 29, 2017

(54) PROCESS FOR INHIBITING SCALE FORMATION WITH UV LIGHT

(71) Applicant: KING FAHD UNIVERSITY OF PETROLEUM AND MINERALS, Dhahran (SA)

(72) Inventors: Chanbasha BASHEER, Karimangalam (IN); Mokhtar SAYED MOHAMED, El wasta (EG)

(73) Assignee: KING FAHD UNIVERSITY OF PETROLEUM AND MINERALS, Dhahran (SA)

(21) Appl. No.: 14/980,583

(22) Filed: Dec. 28, 2015

(51) Int. Cl. B01D 65/08; C02F 5/14; C02F 1/32; C02F 1/44; B01D 61/02; B01D 61/04

(52) U.S. Cl. CPC B01D 65/08; B01D 61/025; B01D 61/04; C02F 1/32; C02F 1/441; C02F 5/14; B01D 2321/343; B01D 2311/12; B01D 2311/2619; B01D 2311/2649; B01D 2321/16; C02F 2103/08

(57) ABSTRACT

A process for inhibiting formation of calcium scale in a reverse osmosis desalination membrane during desalination involving desalinating an aqueous salt solution comprising water, sodium chloride, calcium chloride, and sodium bicarbonate with the reverse osmosis desalination membrane, while concurrently irradiating the aqueous salt solution with a UV light source that emits UV light with a wavelength of 250-400 nm. Scale formation is inhibited by treating a salt solution with the UV light in a continuous or a non-continuous process.

### BACKGROUND OF THE INVENTION

Technical Field

The present invention relates to a process for inhibiting formation of calcium scale in a reverse osmosis desalination membrane during desalination by desalinating an aqueous salt solution and concurrently irradiating the aqueous salt solution with a UV light source.

Description of the Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Potable water scarcity is a mismatch between water supply and water demand. The Kingdom of Saudi Arabia occupies the highest rank among all the states of the world in the production of potable water from the sea by desalination processes, which meets 70% of the Kingdom's drinking water requirement.

Gulf Cooperation Council countries depend on sea water desalination to secure their daily demands [A. M. Shams El Din, et al; Desalination 142 (2002) 151-159—incorporated herein by reference in its entirety]. Water desalination involves thermal and membrane processes triggering the decomposition of HCO₃⁻, resulting in the precipitation of CaCO₃ once its solubility limit is reached, according to the overall reaction

2HCO₃⁻_{(aq)}═CO₃²⁻_{(aq)}+CO_{2 (aq)}+H₂O₍ₗ₎

CO₃²⁻_{(aq)}+Ca^{2|}_{(aq)}═CaCO_{3 (s)}

Calcium carbonate can be found as an amorphous solid and in three different crystalline forms, calcite, aragonite, and vaterite. Aragonite is favored at high temperatures, while calcite is favored at low temperatures. At any temperature, all polymorphs eventually recrystallize to the thermodynamically favored calcite [Ali A. Al-Hamzah, et al; Desalination 338 (2014) 93-105—incorporated herein by reference in its entirety].

Mineral scale formation is an expensive problem in oil, gas, and desalination plants. Scale formation on membrane surfaces in contact with water supersaturated with calcium carbonate creates technical problems including heat transfer hindrance, increased energy consumption, and equipment shutdown [Tao Chen, et al; J. Pet. Sci. Technol. Eng. 46 (2005) 185-194—incorporated herein by reference in its entirety]. Calcite formation increases by increasing the degree of supersaturation, pH, temperature, and CO₂ degassing [Jasbir S. Gill; Desalination 124 (1999) 43-50—incorporated herein by reference in its entirety].

To control scaling in desalination plants, several methods have been adopted. From the early stages of reverse osmosis desalination, acidification of water was one of the approaches considered to affect the decomposition of HCO₃⁻

H⁺_{(aq)}+HCO₃⁻_{(aq)}═H₂O₍ₗ₎+CO_{2 (aq)}

However, acid treatment results in the corrosion of metallic surfaces of multi stage flash units used to purify water [A. M. Shams El Din, et al; Desalination 142 (2002) 151-159—incorporated herein by reference in its entirety].

Antiscalants were developed for scale inhibition on membranes used in desalination plants. They are used in small dosages having a minimal effect on the feed water quality and function by retarding the growth of mineral salt crystals [Alice Antony et al; Journal of Membrane Science 383 (2011) 1-16—incorporated herein by reference in its entirety]. The mechanisms of antiscalants involve dispersion, crystal modification, chelation, blocking precipitation and scale growth. Crystal modification involves the distortion of the formed particle, resulting in irregular, less adhesive crystals, preventing crystal growth at calcite surfaces [W. N. Al Nasser, et al; Chem. Eng. Res. Des. 89 (2011) 500-511—incorporated herein by reference in its entirety]. The choice of antiscalant depends on the degree of saturation, stability, and temperature. However, using antiscalants poses many drawbacks because they are environmental unfriendly due to their chemical effect on the treated water, and the surrounding environment, in addition to the high cost of chemicals.

Therefore, there is an increasing need for new approaches to prevent scale buildup in desalination processes that are environmentally friendly and economically feasible.

In view of the forgoing, one object of the present disclosure is to provide a process for inhibiting formation of calcium scale in a reverse osmosis desalination membrane during desalination that overcomes the aforementioned shortcomings.

### BRIEF SUMMARY OF THE INVENTION

According to a first aspect, the present invention relates to a process for inhibiting formation of calcium scale in a reverse osmosis desalination membrane during desalination involving i) desalinating an aqueous salt solution comprising water, sodium chloride, calcium chloride, and sodium bicarbonate with the reverse osmosis desalination membrane while concurrently ii) irradiating the aqueous salt solution with a UV light source that emits UV light with a wavelength of 250-400 nm.

In one embodiment, the UV light source has an intensity of 90-120 μW/cm².

In one embodiment, the UV light source has an output power of at least 10 W.

In one embodiment, the UV light source is located 1-20 cm above the aqueous salt solution.

In one embodiment, 90-99% of the calcium ions in the aqueous salt solution remain solvated after 120 minutes of irradiating with a UV light of wavelength of 250-275 nm.

In one embodiment, 85-95% of the calcium ions in the aqueous salt solution remain solvated after 120 minutes of irradiating with a UV light of wavelength of 350-400 nm.

In one embodiment, the irradiating decreases scale formation in terms of mass deposited on the reverse osmosis desalination membrane by 85-99% over 60 min relative to the mass of scale deposited on the same reverse osmosis desalination membrane under the same conditions without concurrently irradiating with the UV light.

In one embodiment, the irradiating increases the conductivity of the salt solution by 3-9% in terms of ms/cm over 60 min relative to the conductivity of the same salt solution desalinated with the same reverse osmosis desalination membrane under the same conditions without concurrently irradiating with the UV light.

In one embodiment, the process further comprises pretreating the aqueous salt solution prior to the desalinating.

In one embodiment, the pretreating comprises at least one process selected from the group consisting of prefiltering, buffering, and treating with a chemical antiscalant.

In one embodiment, the pretreating is treating with a chemical antiscalant, and the chemical antiscalant is Hydrex 4102.

In one embodiment, the aqueous salt solution is treated with 1-10 ppm of the Hydrex 4102 antiscalant.

According to a second aspect, the present disclosure relates to a continuous flow reverse osmosis desalination process for inhibiting formation of calcium scale in a reverse osmosis desalination membrane during desalination involving i) flowing an aqueous salt solution comprising water, sodium chloride, calcium chloride, and sodium bicarbonate for pretreatment ii) pretreating the aqueous salt solution to form a pretreated salt solution then iii) desalinating the pretreated salt solution with the reverse osmosis desalination membrane while concurrently iv) irradiating the aqueous salt solution with a UV light source that emits UV light with a wavelength of 250-400 nm.

In one embodiment, the pretreating comprises at least one process selected from the group consisting of prefiltering, buffering, and treating with a chemical antiscalant.

In one embodiment, the pretreating is treating with a chemical antiscalant, and the chemical antiscalant is Hydrex 4102.

In one embodiment, the aqueous salt solution is treated with 1-10 ppm of the Hydrex 4102 antiscalant.

In one embodiment, the aqueous salt solution is irradiated upstream of the pretreatment.

In one embodiment, the aqueous salt solution is irradiated downstream of the pretreatment and upstream of the desalination.

In one embodiment, the UV light source is located 1-20 cm above the aqueous salt solution.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a graph illustrating the effect of UV light wave length on scale inhibition.

FIG. 2 is a graph illustrating the effect of pH on scale inhibition.

FIG. 3 is a graph illustrating the effect of amino tris(methylenephosphonic acid) concentration on scale inhibition.

FIG. 4 is a graph comparing the pH variation of the solution with and without UV light treatment.

FIG. 5 is a graph comparing the conductivity variation of the solution with and without UV light treatment.

FIG. 6 is a graph comparing the mass of a calcium carbonate deposit on a desalination membrane with and without UV light treatment.

FIG. 7A is a XRD spectrum for deposits of an untreated solution. FIG. 7B is an expanded XRD spectrum for deposits of an untreated solution. FIG. 7C is a XRD spectrum for deposits of a UV light treated solution. FIG. 7D is an expanded XRD spectrum for deposits of a UV light treated solution.

FIG. 8A is an SEM image for deposits of an untreated solution. FIG. 8B is an SEM image for deposits of a UV light treated solution

FIG. 9 is a graph comparing the scale inhibition behavior of UV light and Hydrex 4102.

### DETAILED DESCRIPTION OF THE EMBODIMENTS

Referring now to the drawings.

According to a first aspect, the present invention relates to a process for inhibiting formation of calcium scale in a reverse osmosis desalination membrane during desalination involving desalinating an aqueous salt solution comprising water, sodium chloride, calcium chloride, and sodium bicarbonate with the reverse osmosis desalination membrane.

Desalination is a process that removes some amount of salt and other minerals from saline water, brackish water, seawater, or brine. In general brackish water contains 0.05-3% dissolved salts, saline water and seawater contain 3-5% dissolved salts, and brine contains greater than 5% dissolved salts (as presented herein % refers to % by weight based on the total weight of dissolved solids and total solution weight). In terms of the present disclosure, the term “brackish water” is used as a general term for any water than contains more salinity than freshwater (freshwater generally contains less than 0.05% salinity), and may therefore refer to saline water, brackish water, seawater, or brine. Salts that are present in brackish water that may be removed using the process of the present disclosure may be, but are not limited to, cations such as sodium, magnesium, calcium, potassium, ammonium, and iron, and anions such as chloride, bicarbonate, carbonate, sulfate, sulfite, phosphate, iodide, nitrate, acetate, citrate, fluoride, and nitrite.

The desalination process of the present disclosure relates to a reverse osmosis desalination process. Reverse osmosis is a water purification technology that uses a semipermeable membrane, referred to throughout as a “reverse osmosis desalination membrane”, to remove larger particles and molecules from drinking water. In reverse osmosis, an applied pressure is used to overcome osmotic pressure, a colligative property, which is driven by chemical potential, a thermodynamic parameter. Reverse osmosis can remove many types of molecules and ions from solutions, including salts and bacteria, and is used in both industrial processes and the production of potable water. The result is that the solute (dissolved salt) is retained on the pressurized side of the membrane and the pure solvent (water) is allowed to pass to the other side. To be selective, reverse osmosis desalination membranes should not allow large molecules or ions through the pores (holes), but should allow smaller components of the solution (such as the solvent) to pass freely.

The term “membrane” as used herein includes any semi-permeable material which can be used to separate components of a feed fluid into a permeate that passes through the material and a retentate that is rejected or retained by the material. For example, the semi-permeable material may comprise organic polymers, organic co-polymers, mixtures of organic polymers, or organic polymers mixed with inorganics. Suitable organic polymers include polysulfones; poly(styrenes), including styrene-containing copolymers such as acrylonitrile-styrene copolymers, styrene-butadiene copolymers and styrene-vinylbenzylhalide copolymers; polycarbonates; cellulosic polymers, such as cellulose acetate-butyrate, cellulose propionate, ethyl cellulose, methyl cellulose, nitrocellulose, etc.; polyamides and polyimides, including aryl polyamides and aryl polyimides; polyethers; poly(arylene oxides) such as poly(phenylene oxide) and poly(xylene oxide); poly(esteramide-diisocyanate); polyurethanes; polyesters (including polyarylates), such as poly(ethylene terephthalate), poly(alkyl methacrylates), poly(alkyl acrylates), poly(phenylene terephthalate), etc; polysulfides; polymers from monomers having alpha-olefinic unsaturation other than mentioned above such as poly(ethylene), poly(propylene), poly(butene-1), poly(4-methyl pentene-1), polyvinyls, e.g. poly(vinyl chloride), poly(vinyl fluoride), poly(vinylidene chloride), poly(vinylidene fluoride), poly(vinyl alcohol), poly(vinyl esters) such as poly(vinyl acetate) and poly(vinyl propionate), poly(vinyl pyridines), poly(vinyl pyrrolidones), poly(vinyl ethers), poly(vinyl ketones), poly(vinyl aldehydes) such as poly(vinyl formal) and poly(vinyl butyral), poly(vinyl amides), poly(vinyl amines), poly(vinyl urethanes), poly(vinyl ureas), poly(vinyl phosphates), and poly(vinyl sulfates); polyallyls; poly(benzobenzimidazole); polyhydrazides; polyoxadiazoles; polytriazoles; poly(benzimidazole); polycarbodiimides; polyphosphazines; etc., and interpolymers, including block interpolymers containing repeating units from the above such as terpolymers of acrylonitrile-vinyl bromide-sodium salt of para-sulfophenylmethallyl ethers; and grafts and blends containing any of the foregoing. Such organic polymers can optionally be substituted, for example, with halogens such as fluorine, chlorine and bromine; hydroxyl groups; lower alkyl groups; lower alkoxy groups; monocyclic aryl; lower acyl groups and the like. Semi-permeable membranes can also include modified versions of organic polymers. For example, organic polymers can be surface modified, surface treated, cross-linked, or otherwise modified following polymer formation, to provide additional semi-permeable materials that can be included in semi-permeable membranes.

The membranes used for reverse osmosis have a dense layer in the polymer matrix, either the skin of an asymmetric membrane or an interfacially polymerized layer within a thin-film-composite membrane is where the separation occurs. In most cases, the membrane is designed to allow only water to pass through this dense layer, while preventing the passage of solutes/salts. This process requires that a high pressure be exerted on the high concentration side of the membrane, usually 30-250 psi for brackish water, and 600-1200 psi for seawater, which has a natural osmotic pressure of around 390 psi that must be overcome.

In one embodiment, the reverse osmosis desalination membrane of the present disclosure is a thin-film composite membrane. A thin-film composite membrane may be made out of a polyamide, a polystyrene, or a polypropylene layer, which is deposited on top of a polyethersulfone or polysulfone porous layer on top of a non-woven fabric support sheet. The thin-film composite membrane may also be made of other materials, such as other plastic materials, polymers and/or zeolites. In one embodiment, the membrane is a polypropylene membrane. In one embodiment, the membrane is a polysulfone membrane. In an alternative embodiment, the membrane is a polystyrene membrane. In one embodiment, the reverse osmosis desalination membrane of the present disclosure is a nanofilter. The nanofilter may be made from materials such as polyethylene terephthalate or metals such as aluminum. Other types of membranes, as well as other types of materials may be used in to construct the membrane of the present disclosure and are known to those of ordinary skill in the art.

In one embodiment, the process may involve desalinating an aqueous salt solution by passing the solution through two or more membranes.

The process of the present disclosure also involves concurrently irradiating the aqueous salt solution with a UV light source that emits UV light with a wavelength of 250-400 nm, preferably 260-395 nm, more preferably 262-390 nm. Preferably the aqueous salt solution is irradiated under pressure as it passes through the membrane.

Ultraviolet (UV) light is an electromagnetic radiation with a wavelength from 400 nm to 10 nm, shorter than that of visible light but longer than X-rays. In terms of the present disclosure, the UV light source may include a black light (e.g. phosphor-based, mercury-vapor, etc.), a gas-discharge lamp (magnesium fluoride, argon and deuterium arc lamps, an excimer lamp, etc.), a UV LED (diamond, boron nitride, aluminum nitride, aluminum gallium nitride, aluminum gallium indium nitride, etc.), and a UV laser (e.g. nitrogen gas, argon-fluoride, cerium doped lithium strontium aluminum fluoride, diode-pumped solid-state laser, etc.).

In one embodiment, the UV light source has an intensity of 90-120, preferably 95-115, more preferably 100-110 μW/cm².

In one embodiment, the UV light source has an output power of at least 10 W, preferably at least 11 W, more preferably at least 12 W.

It is envisaged, that a UV source that emits a UV light with a shorter wavelength may also be used in the present disclosure. For example, a UV source that produces UV light with a wavelength of 185-250 nm could be used to inhibit scale formation. Therefore, the UV light source may produce UV light classified as UV A, UV B, UV C, near UV, middle UV, Far UV, hydrogen lyman-alpha, vacuum UV, and extreme UV light. Further, it is envisaged that the present process may be adapted to incorporate other light sources that produce other types of light as long as the light source has the desired effect of inhibiting scale formation on a reverse osmosis desalination membrane. Exemplary types of light that may be substituted for UV light include, microwave, infrared, solar, visible light, X-rays that include both soft X-rays and hard X-rays, and gamma rays.

The UV light of the present disclosure may be emitted from a UV lamp having several forms. In one embodiment, the UV lamp is in the form of an elongated structure, and the longitudinal axis of the UV lamp is parallel to the flow of the aqueous salt solution. In one embodiment, the UV lamp is located above the aqueous salt solution. In one embodiment, the UV light source and/or UV lamp is located 1-20 cm, preferably 1-15 cm, more preferably 1-10 cm above the aqueous salt solution. Alternatively, the UV light source may be water proof, or water resistant, and the UV lamp is submerged in the aqueous salt solution. In the case where the UV light source is submerged, the UV light source may be encased in a barrier, such as for example a water proof casing, housing, or membrane, so long as the barrier permits UV light to pass through while preventing water egress into the encased UV lamp. In one embodiment, the water proof casing is a transparent water proof barrier. In an alternative embodiment, the UV light source may comprise a plurality of UV lights (i.e. LEDs, individual light bulbs, etc.), and the UV lights may be spaced apart in a variety of vertically and horizontally separated levels. In this scenario, the spaced UV light sources may either be located above the aqueous salt solution, or alternatively submerged under the aqueous salt solution. Further, the UV light sources may be located both above the aqueous salt solution and submerged in the salt solution. As an example, an aqueous salt solution that flows through a cylindrical conduit may be irradiated with a plurality of UV light sources where the UV sources are spaced apart within the conduit circumferentially.

Most water sources, especially saline containing water sources contain a variety of calcium-based salts, such as calcium carbonate and calcium bicarbonate. Water desalination results in the precipitation of CaCO₃, once the solubility limit of CaCO₃ is reached. The resulting scale or incrustation can build up on desalination equipment, and cause technical problems and eventual equipment shutdown. In terms of the present invention, the term “scale” refers to calcium scale, and more specifically CaCO₃. However, other types of scale include calcium sulfate, barium sulfate, strontium sulfate, calcium phosphate, calcium fluoride, calcium silicate, magnesium hydroxide, zinc carbonate, and the like. It is envisaged that the process of the present disclosure may be used to inhibit the formation of other types of scale, in addition to calcium carbonate.

The term “deposit” or “deposited” as used herein, refers to any sparingly soluble salt, as defined hereinabove, which has become insoluble and has salted out of the solution. The term may be used, and have substantially the same meaning as the terms “a precipitate”, “precipitating” and “precipitation”.

Scale formation can be monitored by logging the concentration of ions in solution over time. As the concentration of ions dissolved in solution decrease, it can be assumed that the decrease in ion concentration is a result of precipitation.

In one embodiment, 90-99%, preferably 92-98%, more preferably 93-97% of the calcium ions in the aqueous salt solution remain solvated after 120 minutes of irradiating with a UV light of wavelength of 250-275 nm, preferably 255-270 nm, more preferably 260-268 nm.

In one embodiment, 85-95%, preferably 90-94%, more preferably 91-93% of the calcium ions in the aqueous salt solution remain solvated after 120 minutes of irradiating with a UV light of wavelength of 350-400 nm, preferably 360-395 nm, more preferably 370-390 nm.

During reverse osmosis desalination, scale build up may occur primarily on the desalination membrane, as the aqueous salt solution is concentrated at the membrane partition.

Scale formation and buildup can also be monitored by weighing the desalination membrane over time. In one embodiment, the irradiating decreases scale formation in terms of mass deposited on the reverse osmosis desalination membrane by 85-99%, preferably 86-95%, more preferably 87-93% over 60 min relative to the mass of scale deposited on the same reverse osmosis desalination membrane under the same conditions without concurrently irradiating with the UV light.

The formation of calcium scale may further be monitored by logging the conductivity of the solution being desalinated over time. In this case, the number of dissolved ions in solution results in a higher conductivity. Therefore, a conductivity that decreases overtime is an indicator of the formation of precipitation (i.e. scale formation).

In one embodiment, the irradiating increases the conductivity of the salt solution by 3-9%, preferably 3.5-7%, more preferably 4-6% in terms of millisiemens (ms)/cm over 60 min relative to the conductivity of the same salt solution desalinated with the same reverse osmosis desalination membrane under the same conditions without concurrently irradiating with the UV light.

In one embodiment, the process further comprises pretreating the aqueous salt solution prior to the desalinating. The pretreating of the present disclosure may comprise at least one process selected from the group consisting of prefiltering, buffering, and treating with a chemical antiscalant.

In regard to the present disclosure, prefiltering may involve a sediment filter or a plurality of sediment filters with varying pore sizes, an activated carbon filter, or filtration through a cellulose triacetate filter. In terms of the present desalination process, a sediment filter is used to remove particles such as rust and salt precipitates from the aqueous salt solution. By passing the salt solution through a series of sediment filters with varying pore sizes (e.g. largest pore size to smallest pore size), different sized particles can be removed from the salt solution, while still maintaining a suitable flow rate through the filters. The activated carbon filter is used to trap organic chemicals and chlorine present in the aqueous salt solution. Further, a cellulose triacetate filter can also be used to remove particles from the aqueous salt solution in instances where the aqueous salt solution is chlorinated.

In one embodiment, the pretreating is a buffering process. Scale formation is largely inhibited at lower pH, however acidic solutions corrode the desalination equipment. Therefore, buffering with chemical buffers may be used to achieve a solution pH that minimizes scale formation, while also protects the desalination process equipment from corrosion. In terms of the present desalination process, the pH of the aqueous salt solution is maintained at 6-9, preferably 6.5-8.5, more preferably 6.8-8.1.

Exemplary chemical buffers include hydrochloric acid, sodium bicarbonate, monosodium phosphate, disodium phosphate, sodium tripolyphosphate, sodium carbonate, sodium hydroxide, sodium silicate, sulfuric acid, calcium hydroxide, calcium oxide, and the like.

In one embodiment, the pretreating is treating with a chemical antiscalant.

The term “antiscalant” or “scale inhibitor” refers to any chemical agent that prevents, slows, minimizes, or stops the precipitation of scale from the aqueous salt solution. Calcium-based scale inhibitors which may be used in a pretreating step in the present disclosure include, phosphine or sodium hexametaphosphate, sodium tripolyphosphate and other inorganic polyphosphates, hydroxy ethylidene diphosphonic acid, butane-tricarboxylic acid, phosphonates, or phosphonic acids such as amino tris(methylenephosphonic acid) (ATMP), etc. carboxyl group-containing starting material acids, maleic acid, acrylic acid and itaconic acid and the like, polycarboxylic acid polymers, sulfonated polymers, vinyl sulfonic acid, allyl sulfonic acid, and 3-allyloxy-2-hydroxy-propionic acid and other vinyl monomers having a sulfonic acid group, or a non-ionic acrylamide monomer from the vinyl copolymer, and the like. Antiscalants that may be used in the reverse osmosis membrane of the present disclosure include the Hydrex™ 4000 series antiscalants as sold by Veolia Water Solutions and Technologies. Exemplary antiscalants include Hydrex 4101, 4102, 4103, 4104, 4105, 4106, 4107, 4109, 4115,4116, etc. “Hydrex 4102” refers to an antiscalant made of a phosphonate blend, that inhibits the formation of calcium carbonate scales. The phosphonate blend of Hydrex 4102 is a mixture of amino tris(methylenephosphonic acid) and phosphonic acid, with pH of 11.00-12.00. In one embodiment, the antiscalant is Hydrex 4102.

In one embodiment, the aqueous salt solution is treated with 1-10 ppm, preferably 1-9 ppm, more preferably 1-8 ppm of the Hydrex 4102 antiscalant.

Other processes may be used to treat the water for other impurities (bacteria, algae, etc.). This includes adding an algicide to reduce algae (copper sulfate), a coagulant or flocculant to remove suspended and colloidal solids (aluminum chlorohydrate, aluminum sulfates, ferric chloride, ferric sulfate, sodium aluminates, polyacryl amides, polyaluminum chlorides, polyaluminum silica sulfates, polydiallyldimethylammonium chlorides, sodium silicates), an oxidant (chlorine, KMnO4, chlorine dioxide), a disinfectant (chlorine, ozone, hydrogen peroxide, calcium hypochlorite, sodium hypochlorite).

Calcium carbonate can be precipitated from aqueous solution in one or more different compositional forms: vaterite, calcite, aragonite, amorphous, or a combination thereof. Generally, vaterite, calcite, and aragonite are crystalline compositions and may have different morphologies or internal crystal structures, such as, for example, rhombic, orthorhombic, hexagonal, or variations thereof.

Vaterite is a metastable phase of calcium carbonate at ambient conditions at the surface of the earth and belongs to the hexagonal crystal system. Vaterite is less stable than either calcite or aragonite, and has a higher solubility than either of these phases. Therefore, once vaterite is exposed to water, it may convert to calcite (at low temperature) or aragonite (at high temperature: ˜60° C.). The vaterite form is uncommon because it is generally thermodynamically unstable.

The calcite form is the most stable form and the most abundant in nature and may have one or more of several different shapes, for example, rhombic and scalenohedral shapes. The rhombic shape is the most common and may be characterized by crystals having approximately equal lengths and diameters, which may be aggregated or unaggregated. Calcite crystals are commonly trigonal-rhombohedral. Scalenohedral crystals are similar to double, two-pointed pyramids and are generally aggregated.

The aragonite form is metastable under ambient temperature and pressure, but converts to calcite at elevated temperatures and pressures. The aragonite crystalline form may be characterized by acicular, needle- or spindle-shaped crystals, which are generally aggregated and which typically exhibit high length-to-width or aspect ratios. For instance, aragonite may have an aspect ratio ranging from about 3:1 to about 15:1.

According to a second aspect, the present disclosure relates to a continuous flow reverse osmosis desalination process for inhibiting formation of calcium scale in a reverse osmosis desalination membrane during desalination involving i) flowing an aqueous salt solution comprising water, sodium chloride, calcium chloride, and sodium bicarbonate for pretreatment ii) pretreating the aqueous salt solution to form a pretreated salt solution then iii) desalinating the pretreated salt solution with the reverse osmosis desalination membrane while concurrently iv) irradiating the aqueous salt solution with UV light source that emits UV light with a wavelength of 250-400 nm.

The continuous flow process of the present disclosure refers to a continuous process that involves a pretreatment stage, an irradiation stage, and a desalination stage. In general, the pretreatment stage is upstream of the desalination stage. Further, the desalination stage is the last of the three stages listed above. The irradiation stage may be at various positions within the continuous flow process, and several of these embodiments are discussed below.

In the present disclosure, a brackish solution is flowed to a pretreatment reactor. In one embodiment, the pretreating comprises at least one process selected from the group consisting of prefiltering, buffering, and treating with a chemical antiscalant. Examples of which were described heretofore.

In one embodiment, the pretreating is treating with a chemical antiscalant, and the chemical antiscalant is Hydrex 4102. In one embodiment, the aqueous salt solution is treated with 1-10 ppm, preferably 1-9 ppm, more preferably 1-8 of the Hydrex 4102 antiscalant.

The continuous flow process next involves flowing the pretreated brackish solution to a desalination stage.

Concurrent to the pretreatment and the desalination, the brackish solution is irradiated with a UV light. In one embodiment, the aqueous salt solution is irradiated upstream of the pretreatment. In one embodiment, the aqueous salt solution is irradiated downstream of the pretreatment and upstream of the desalination. Regardless of the placement of the UV light source within the continuous flow process, the irradiating is performed concurrently with the desalination step, in light of the fact the process is a continuous flow process.

Each of the stages of the continuous flow process may be associated with a vessel (e.g. a pretreatment vessel for the pretreatment stage, a desalination vessel for the desalination stage where the desalination membrane is located, etc.).

In one embodiment, the UV light source is located 1-20 cm above the aqueous salt solution.

In one embodiment, the UV light source may be located within the pretreatment vessel, such that the irradiation stage and the pretreatment stage occur simultaneously, and both are upstream of the desalination stage. In an alternative embodiment, the UV light source may be located within the desalination vessel, such that the irradiation stage and the desalination stage occur simultaneously, and both are downstream of the pretreatment stage.

The UV light source of the present disclosure, while located proximal to the surface of the flowing brackish solution, may be located within the feed lines/flow tubes that feed the pretreatment step or that fluidly connect the pretreatment step to the desalination step with the desalination membrane. For example, the UV light source may be attached to the ceiling of a flow tube or conduit, and may be an elongated UV light, where the longitudinal axis of the elongated UV light runs parallel to the longitudinal axis of the flow tube. Alternatively, it is envisaged that the UV light source may be located within a separate irradiation vessel, which is located at one or more positions within the flow process. For example, the flow process may involve consecutively flowing a brackish solution to an irradiation stage, to a pretreatment stage, then to the desalination membrane. In an alternative embodiment, the flow process involves consecutively flowing a brackish solution through a pretreatment vessel, to an irradiation vessel, then to the desalination membrane. Further, the continuous flow process may include more than one UV light sources, located within more than one irradiation vessels, and the irradiation vessels may be located at different stages of the desalination process.

After desalinating the brackish solution, other post-treatment processes can be performed on the desalinated water. These include bacteriocidal treatments, such as UV light treatment after the desalination. The post-treatment process may also include fluoridation, by adding fluorine ions to the water. Examples of fluoridation agents include, but are not limited to sodium fluoride, sodium fluorosilicate, fluorosilicic acid.

The examples below are intended to further illustrate the process for inhibiting the formation of calcium scale in a reverse osmosis membrane and are not intended to limit the scope of the claims.

### EXAMPLE 1

### Materials

Calcium chloride (CaCl₂.6H₂O), sodium chloride (NaCl), and sodium bicarbonate (NaHCO₃) of analytical grade were supplied by Sigma Aldrich. Hydrex 4102 RO antiscalant was supplied by VEOLIA WATER STI. Its chemical constituents are amino tris (methylenephosphonic acid), and phosphonic acid, with pH of 11.00-12.00, and specific gravity of 1.35-1.45. The working solution was prepared by mixing sodium chloride, calcium chloride, and sodium bicarbonate solutions prepared from standardized stock solutions, prepared using deionized water using a Millipore Q-Plus 185 system. The pH of the solutions was measured by a glass/saturated calomel electrode (Metrohm), calibrated before and after each experiment with 4, 7, and 10 standard buffer solutions. The pH of the working solution was adjusted by the addition of hydrochloric acid and ammonium hydroxide. The calcium carbonate precipitation process was initiated when adding calcium chloride and sodium bicarbonate in the presence and absence of UV light.

### Methods

UV radiation was generated by a UV lamp source having a 15 mm diameter, 106 μW/cm² intensity, 54V operating voltage, and 12 W output power, emitting a broad band of UV light, with 8 filters for specific wave length selection, producing an average intensity of 2 mW/cm² at a distance of 2 cm from the working solution.

pH, and conductivity values of the working solutions were monitored using Thermo Scientific Orion pH electrode.

For determination of the calcium ion concentration, 10 ml of the working solution was taken every 15 min, filtered by 0.025 μm membrane filter, and titrated versus an EDTA standardized solution.

The weight measurements of the calcium carbonate scale deposits were carried out by weighing the polypropylene and polystyrene membranes using a Mettler weighing balance with 4 decimal places, keeping them inside the working solutions for 30, and 60 minutes, drying in an oven for 1 h at 110° C., and then weighing the membranes together with the deposits.

At the end of the experiments, the solutions were filtered, and the precipitates were collected and examined by XRD for phase analysis.

### EXAMPLE 2

### Results and Discussion

Carbonate scale mitigation in water using UV light was only reported by Dal as [E. Dalas, S. Koutsopoulos, J; J. Colloid Interface Sci. 155 (1993) 512—incorporated herein by reference in its entirety]. For the crystal growth of sparingly soluble salts, as calcium carbonate, the rate limiting step involves the dehydration of the growth units, and the surface diffusion of these dehydrated growth units into the lattice from the adsorption site. Dalas proposed that UV radiation changes the electronic structure of the growth unit, hindering the attraction of the growth units to water molecules, retarding the dehydration of the growth units. On the other hand, carboxylic acids show a decrease in acidity in the excited singlet state relative to the ground state, retarding the diffusion of the growth units into the lattice via changes of the surface properties of calcium carbonate at atomic level.

UV radiation showed drastic changes in calcium carbonate scale inhibition. Factors affecting the scale inhibition like radiation energy, pH, and antiscalant concentration have been studied.

Calcium carbonate scale inhibition (CCI %) was calculated as:

$$CCI \% = \frac{{[ {Ca}^{+ 2} ]}_{Sample}}{{[ {Ca}^{+ 2} ]}_{Initial}} \times 100$$

$$where {\text{:} \\ [ {Ca}^{+ 2} ]}_{Initial} is the calcium ion concentration at t = {0 \\ [ {Ca}^{+ 2} ]}_{Sample } is the calcium ion concentration at time ( t )$$

### EXAMPLE 3

### Factors Affecting Scale Inhibition

### Effect of Light Wavelength

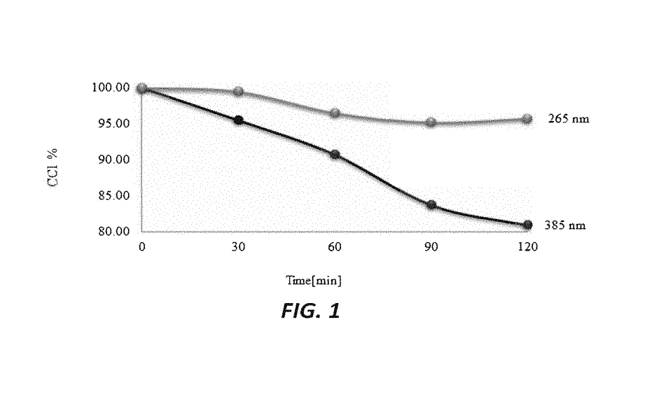

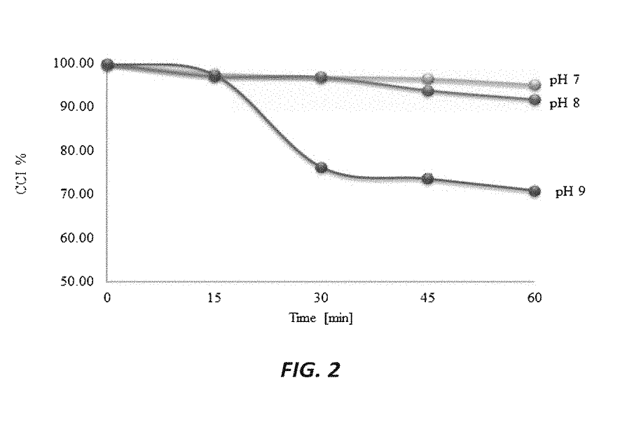

The effect of radiation energy was studied in UV and visible regions. For the visible region, the solution was irradiated with 385 nm radiation, providing scale inhibition of 80.90% after 120 minutes, compared to 95.66% when irradiating with 265 nm UV radiation, as shown in FIG. 1.

The effect of UV radiation can be explained in terms of the calcium ion acid base character. Calcium ion is a weak acid, and when excited it becomes much weaker. Irradiating the calcium solution with 385 nm visible radiation excites some of the energetic and weakly acidic calcium ions, those ions are not able to recombine with the carbonate ion present in solution, and calcium carbonate precipitation is eventually retarded. When shifting from visible to UV region, the radiation energy increases, exciting more calcium ions, resulting in more efficient scale inhibition.

### Effect of pH

FIG. 2 depicts the effect of pH on calcium carbonate scale inhibition using UV light of 265 nm radiation during 60 minutes. At pH 7.00, the scale inhibition was almost steady reaching 97.15% after 60 minutes, while decreasing to 91.80% at pH 8.00. On the other hand, increasing pH to 9.00 had a drastic effect on the scale inhibition behavior, decreasing slowly in the first 15 minutes and then sharply in the next 15 minutes, while giving an asymptotic trend during the last 30 minutes, reaching 71.06% at 60 minutes.

This dramatic effect of pH can be interpreted based on the pH dependence of carbonate concentration in solution. Bicarbonate dissociates into carbonate according to the equation:

HCO₃⁻(aq)⇄CO₃²⁻(aq)+H⁺(aq) (pKₐ=10.33)

According to Henderson-Hasselbalch equation, as pH increases, the carbonate concentration increases as indicated in Table 1.

pH=pKₐ+Log [CO₃²⁻]/[HCO₃⁻]

Increasing pH by 2 units increases the carbonate concentration by 2 orders of magnitude, increasing the chance of calcium and carbonate ions recombination, hence increasing the rate of calcium carbonate precipitation. This finding can be supported by the fact that in a carbonate system, the dissolved carbon is distributed among three species H₂CO₃, HCO₃⁻ and CO₃²⁻ as a function of pH. This distribution of carbonate species can be derived from the Henderson-Hasselbalch relationship knowing pH and pK's.

TABLE 1
Effect of pH on carbonate concentration in 9.50 mM bicarbonate solution

| pH | [CO₃²⁻]/mM |
|---|---|
| 7 | 4.44 × 10⁻⁹ |
| 8 | 4.44 × 10⁻⁸ |
| 9 | 4.44 × 10⁻⁷ |

### Effect of Hydrex 4102 Concentration

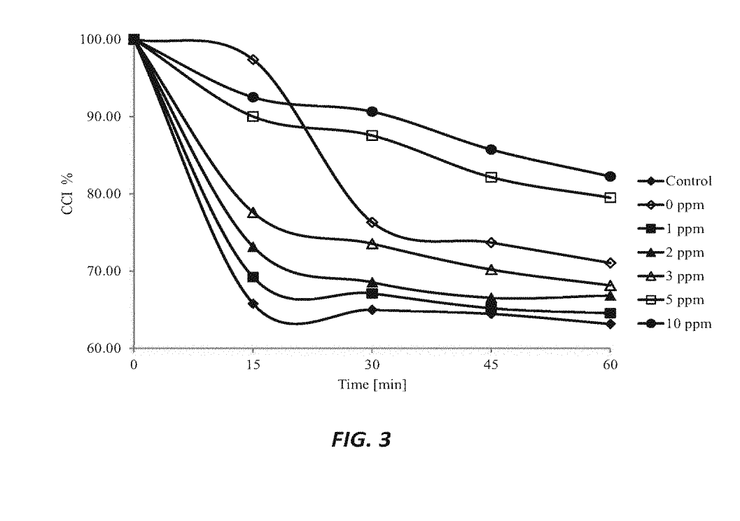

The effect of the addition of aminotris(methylenephosphonic acid) (ATMP) during UV irradiation of the working solution was investigated by the addition of the antiscalant at different dosages from 1 to 10 ppm. As depicted in FIG. 3, the addition of 1 and 2 ppm increased the precipitation of calcium carbonate relative to the control case because UV radiation has dissociated the antiscalant into fragments unable to inhibit the scale formation. When increasing the dosage to 3 ppm, the scale inhibition has been enhanced relative to the addition of 1 and 2 ppm because the antiscalant molecules have blocked some of the active sites that are available for crystal growth. Meanwhile, increasing the antiscalant concentration to 5 ppm and 10 ppm has raised the scale inhibition to 96% compared to 36% for the untreated case.

### EXAMPLE 4

### Water Chemistry

pH

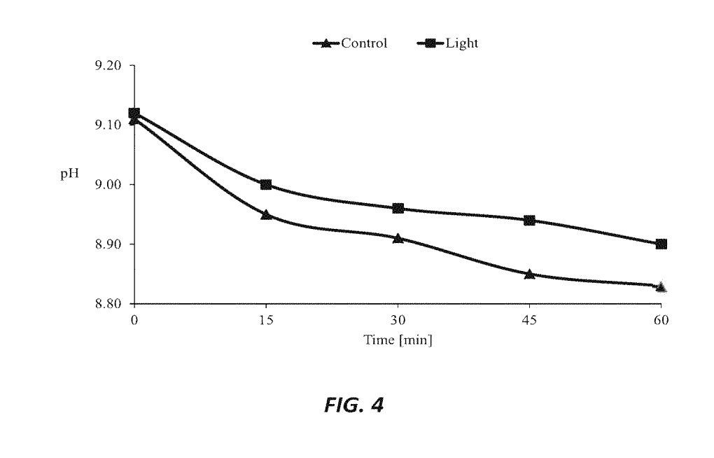

FIG. 4 illustrates the variation of pH in the case of control and UV treated water. The pH of the untreated sample decreased from 9.00 to 8.9, while that of the UV treated sample decreased from 9.00 to 8.80, because of the release of the protons resulting from calcium carbonate precipitation according to:

Ca^{2|}_{(aq)}+HCO₃⁻_{(aq)}→CaCO_{3 (s)}+H^{|}_{(aq)}

### Conductivity

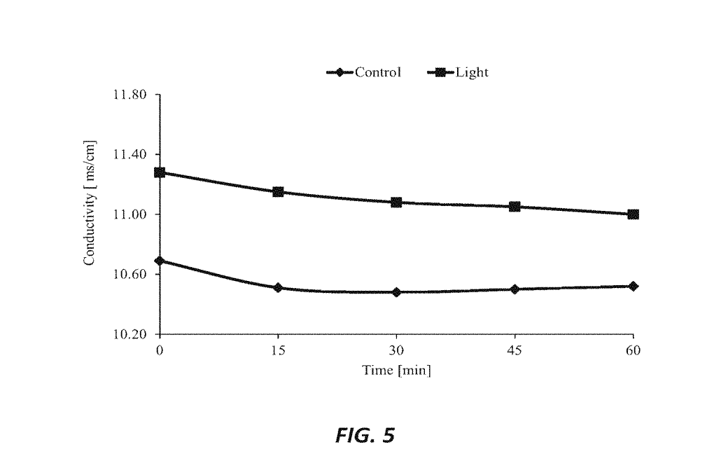

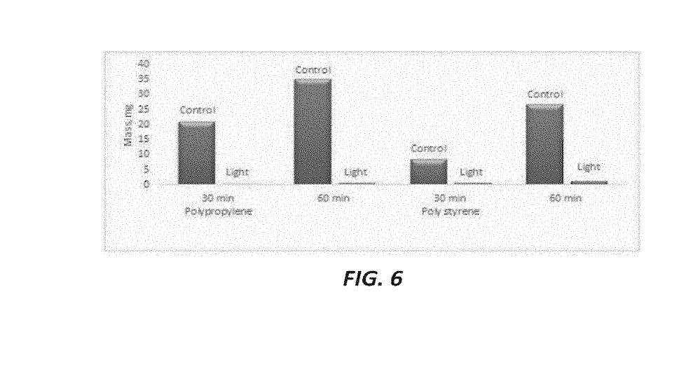

The electrical conductivity of solution is a measure of the extent of precipitation because as precipitation occurs, more ions will be driven off from the solution, lowering the electrical conductivity. FIG. 5 shows that the conductivity drop in case of untreated water is higher compared to that in case of the UV irradiated water since calcium carbonate has precipitated more in case of the untreated sample leading to more calcium and bicarbonate ions consumption form solution, lowering the electrical conductivity with time.

### EXAMPLE 5

### Characterization of Scale Deposits

### Membrane Scale Deposit Weight Measurement

FIG. 6 shows the mass of calcium carbonate deposited on polypropylene and polysulfone membranes kept inside the working solutions for 30, and 60 minutes. It is very clear that the amount of scale deposited in case of UV-treated sample is insignificant compared to that of the untreated one. This observation is extremely valuable regarding the life time of the desalination membranes that is affected by the amount of scale deposit. Thus, using UV light for scale inhibition increases the life time of the membrane due to the reduced membrane fouling.

### XRD Analysis

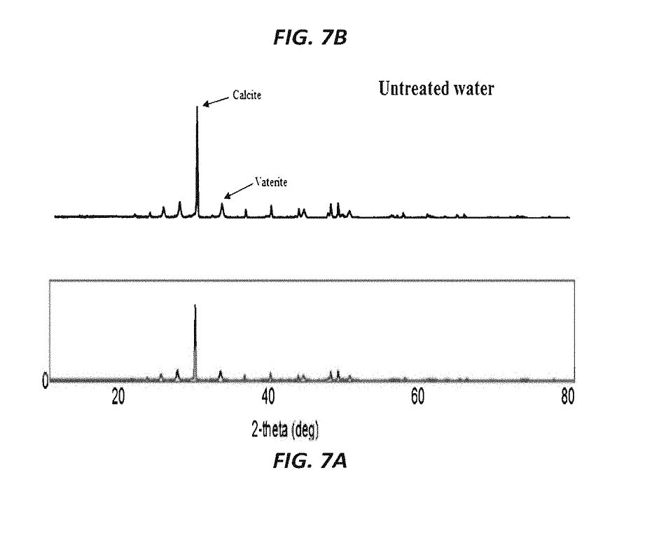

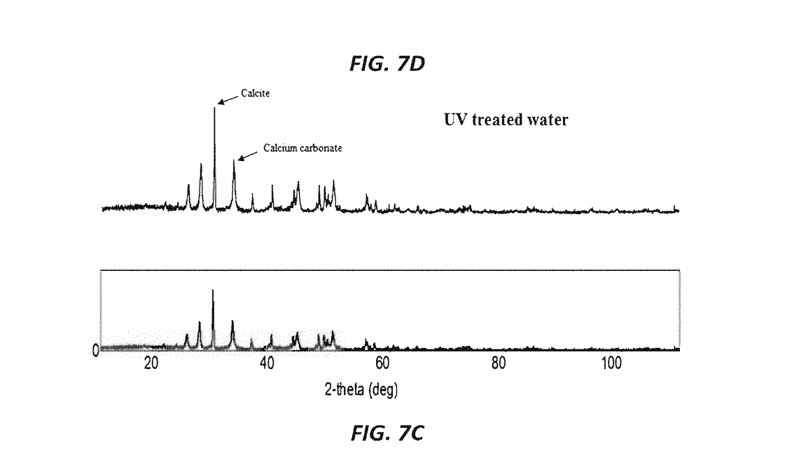

FIG. 7A-7D show XRD images of the deposits obtained from untreated, and UV-Light treated water. Calcium carbonate deposited in the case of untreated samples contains calcite and vaterite, while only calcite was formed in case of the UV light treated, that is less dense, less adherent, and easily-removed when deposited. The formation of calcite scale in the treated case may be due to the formation of CaCO₃ in the bulk water due to the supersaturated condition, precipitating in bulk water at lower temperatures than those directly precipitated on the surface, hence resulting in the formation of calcite scales rather than aragonite.

### SEM Analysis

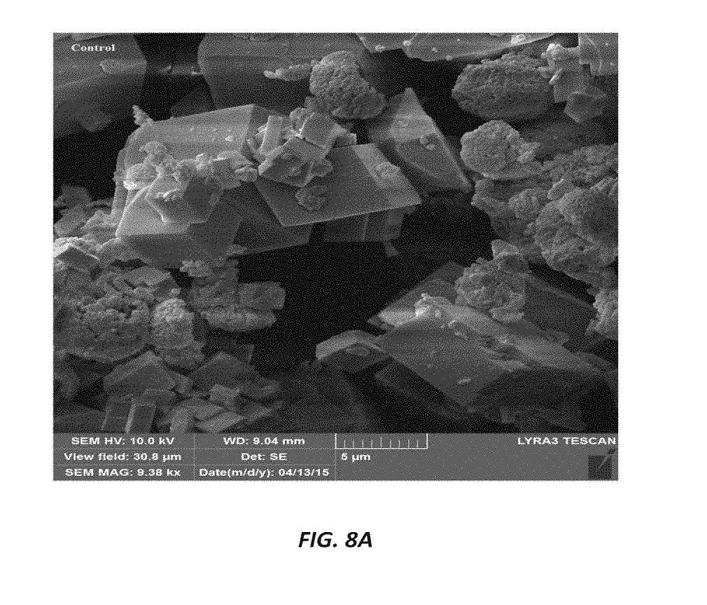

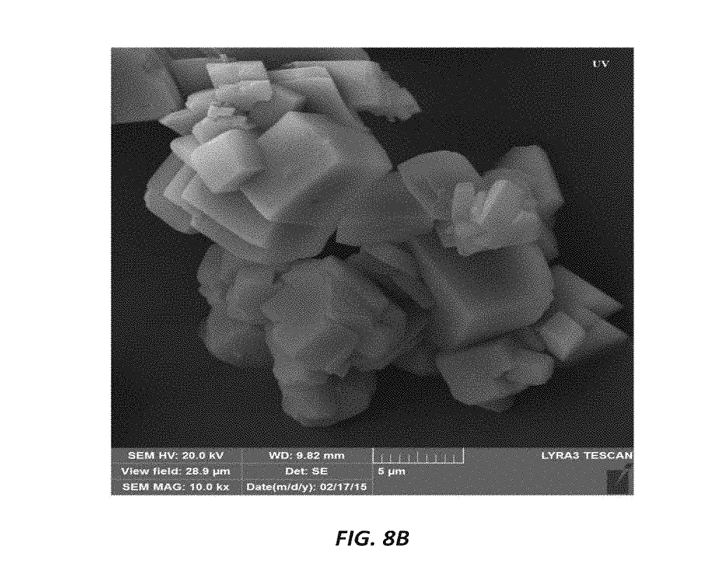

FIG. 8A and FIG. 8B shows SEM images of the deposits obtained from untreated, and UV light treated water. The SEM images also show the deposition of calcite crystals in case of the UV light treated sample, while the calcium carbonate deposited in case of untreated sample consists of calcium carbonate, and vaterite.

### EXAMPLE 6

Comparison of UV Treatment with Chemical Treatment

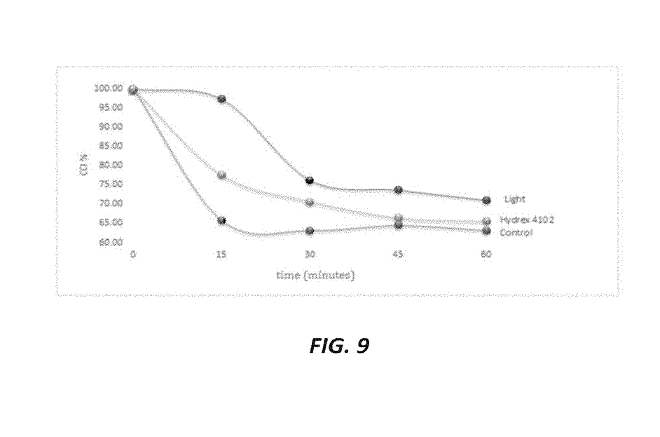

FIG. 9 illustrates the comparison of the scale inhibition behavior of UV light and Hydrex 4102 antiscalant. After 60 minutes, the scale inhibition of UV light treatment is 71.06%, higher than that obtained with the addition of 3 ppm of Hydrex 4102 antiscalant, which is 65.52%. Hence, UV light treatment is much more efficient compared to commercial antiscalants. Application of UV has more advantages than the chemical treatment process. UV is commonly used in the water treatment industry to kill pathogens and does not have any harmful effect when compared to chemical antiscalants.

1: A process for inhibiting formation of calcium scale in a reverse osmosis desalination membrane during desalination, comprising
desalinating an aqueous salt solution comprising water, sodium chloride, calcium chloride, and sodium bicarbonate with the reverse osmosis desalination membrane; while concurrently
irradiating the aqueous salt solution with a UV light source that emits UV light with a wavelength of 250-400 nm.

2: The process of claim 1, wherein the UV light source has an intensity of 90-120 μW/cm².

3: The process of claim 1, wherein the UV light source has an output power of at least 10 W.

4: The process of claim 1, wherein the UV light source is located 1-20 cm above the aqueous salt solution.

5: The process of claim 1, wherein 90-99% of the calcium ions in the aqueous salt solution remain solvated after 120 minutes of irradiating with a UV light of wavelength of 250-275 nm.

6: The process of claim 1, wherein 85-95% of the calcium ions in the aqueous salt solution remain solvated after 120 minutes of irradiating with a UV light of wavelength of 350-400 nm.

7: The process of claim 1, wherein the irradiating decreases scale formation in terms of mass deposited on the reverse osmosis desalination membrane by 85-99% over 60 min relative to the mass of scale deposited on the same reverse osmosis desalination membrane under the same conditions without concurrently irradiating with the UV light.

8: The process of claim 1, wherein the irradiating increases the conductivity of the salt solution by 3-9% in terms of ms/cm over 60 min relative to the conductivity of the same salt solution desalinated with the same reverse osmosis desalination membrane under the same conditions without concurrently irradiating with the UV light.

9: The process of claim 1, further comprising pretreating the aqueous salt solution prior to the desalinating.

10: The process of claim 9, wherein the pretreating comprises at least one process selected from the group consisting of prefiltering, buffering, and treating with a chemical anti scalant.

11: The process of claim 10, wherein the pretreating is treating with a chemical antiscalant, and the chemical antiscalant is Hydrex 4102.

12: The process of claim 11, wherein the aqueous salt solution is treated with 1-10 ppm of the Hydrex 4102 antiscalant.

13: A continuous flow reverse osmosis desalination process for inhibiting formation of calcium scale in a reverse osmosis desalination membrane during desalination, comprising:
flowing an aqueous salt solution comprising water, sodium chloride, calcium chloride, and sodium bicarbonate for pretreatment;
pretreating the aqueous salt solution to form a pretreated salt solution; then
desalinating the pretreated salt solution with the reverse osmosis desalination membrane; while concurrently
irradiating the aqueous salt solution with a UV light source that emits UV light with a wavelength of 250-400 nm.

14: The continuous flow process of claim 13, wherein the pretreating comprises at least one process selected from the group consisting of prefiltering, buffering, and treating with a chemical antiscalant.

15: The continuous flow process of claim 14, wherein the pretreating is treating with a chemical antiscalant, and the chemical antiscalant is Hydrex 4102.

16: The continuous flow process of claim 15, wherein the aqueous salt solution is treated with 1-10 ppm of the Hydrex 4102 antiscalant.

17: The continuous flow process of claim 13, wherein the aqueous salt solution is irradiated upstream of the pretreatment.

18: The continuous flow process of claim 13, wherein the aqueous salt solution is irradiated downstream of the pretreatment and upstream of the desalination.

19: The continuous flow process of claim 13, wherein the UV light source is located 1-20 cm above the aqueous salt solution.
